(19) United States
(12) Patent Application Publication
(10) Pub. No.: US 2004/0224590 A1
(43) Pub. Date: Nov. 11, 2004

(54) Thermoplastic/fiber material composites, composite/metallic articles and methods for making composite/metallic articles

(76) Inventors: George Rawa, Harleysville, PA (US); Keith Robert Brand, Pottstown, PA (US); Christopher D. Toto, North Wales, PA (US); Jason F. Gabriel, Gilbertsville, PA (US); Kevin D. Fortunato, Hatboro, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/814,523

(22) Filed: Mar. 31, 2004

Related U.S. Application Data
(60) Provisional application No. 60/459,446, filed on Mar. 31, 2003.

(51) Int. Cl. B32B 27/04; B32B 5/02; B32B 27/12

(52) U.S. Cl. 442/176; 442/179; 442/203; 442/232; 156/289

(57) ABSTRACT

Metallic/composite articles and methods for making such articles as well as thermoplastic/fiber material composites are provided herein. Composites include a woven fiber material such as carbon fiber material and a thermoplastic selected from a group consisting of polyarylene ether ketone, polyarylene ether ketone ketone, polyarylene ether ether ketone, and derivatives thereof. Articles include such composites and a base metal, wherein the composite is directly adhered to a first surface of the base metal. Articles may be made by contacting a thermoplastic/fiber material composite with a first surface of a base metal; contacting a release sheet with a top of the thermoplastic/fiber material composite; contacting a first surface of a mold with the release sheet and applying heat and pressure to the thermoplastic/fiber material composite sufficient to directly adhere the thermoplastic/fiber material composite to the first surface of the base metal to form an article; and removing the release sheet from the article.

### CROSS-REFERENCE TO RELATED APPLICATIONS

This application claims the benefit of priority under 35 U.S.C. § 119(e) based upon U.S. Provisional Patent Application No. 60/459,446, filed Mar. 31, 2003, the entire disclosure of which is incorporated herein by reference.

### BACKGROUND OF THE INVENTION

Compared to metallic materials, thermoplastic polymeric materials are typically not as stiff or strong and tend to deform over long periods of time. However, the advantages of thermoplastics include their light weight, high toughness or ductility, ability to be reformed and faster processing times.

Applications for thermoplastic polymers as integral to composite materials is also a growing field for developing products with varying desired engineering properties. Composite materials include those formed using carbon fibers compounded with, immersed in or impregnated with or covered with certain thermoplastic polymers resulting in materials with remarkable structural capabilities. As a result, carbon fiber reinforced thermoplastics continue to find new applications utilizing a variety of polymers and copolymers many of which have found popular use, with a wide range of properties and cost.

Friction applications are areas in which engineering polymers and composite materials are the subject of much research and investigation, particularly materials capable of operating at high temperatures which can be used in applications where materials such as metals, asbestos and graphite are traditionally used. More recently, carbon fiber-reinforced thermoplastic polymers have established themselves as composites having desirable friction and wear properties. Exemplary articles formed by or including such composites include rotary paddle pumps, bearing materials, automotive continuous slip surface applications such as locking differential and clutch assemblies, sealing elements and plain bearings, power transmission-energy absorption devices, dual-layer clutch systems and roller bearings for a variety of industrial applications that have at least, in part, thermoplastic and/or composite materials which have adequate physical and thermal properties and/or chemical resistance.

However, despite the advances in carbon fiber reinforced thermoplastics, articles formed using composite thermoplastics have shortcomings in terms of their physical, thermal or chemical characteristics, in terms of the limited number of structural applications to which they can be applied, and in terms of how the composites interact and/or are bonded to base materials.

These shortcomings are attributed, in part, to several important processing considerations associated with the manufacture of high performance composite thermoplastics. The thermal properties of high performance thermoplastics are, for example, important processing variables and therefore must be closely controlled. While thermoplastic polymers are typically received for processing fully polymerized and in a solid form, they must be heated above their melting temperature in order for the reinforcement fibers, such as carbon fibers, to be fully infused prior to incorporating the composite material into a desired final product. Thus, forming a composite material with, for example, polyether ether ketone (PEEK) as the thermoplastic resin is conducted by heating to a temperature no lower than the melting temperature of about 343° C. and usually at a processing temperature of about 400° C.

Likewise, cooling rates for many thermoplastic polymers are important for processing considerations since semi-crystalline properties depend on the final degree of crystal formation and therefore the rate of cooling. Typically, a higher percentage of semi-crystalline structure will be achieved using slower cooling rates. Therefore, for high performance thermoplastics, such as PEEK and similar polymers, it is critical that the polymers' thermal and cooling rates during composite manufacture be carefully specified.

When forming carbon fiber reinforced thermoplastics, consideration must also be given to the type, size and method of forming the carbon fibers before they are immersed in and/or impregnated with thermoplastic resin. Carbon fibers can be, for example, any fibers, continuous, long fibers, short fibers, or chopped fibers. Also, a carbon fiber sheet, fabric or cloth can be formed in which the construction is woven in a variety of single or multi-dimensional forms or braided in flat or continuous/circular forms. Still other carbon fiber constructions are possible.

Other important aspects of the manufacture of fiber reinforced thermoplastics are whether derivatives of the thermoplastics can be used effectively and whether fibers can be spun or co-mingled with other fibers such as glass, silicon carbide or other fiber types.

While it would be desirable from a properties and cost perspective to successfully develop carbon fiber reinforced thermoplastic composite/metal substrate parts, there is still a need in the art for achieving this goal effectively. To avoid the difficulties associated with bonding fiber-reinforced thermoplastics to base materials, like steel for example, the use of high performance composite thermoplastics has been primarily limited to non-bonded applications in which the articles of construction consist entirely of the composite thermoplastic. Thus far, efforts to effectively bond carbon fiber-reinforced thermoplastics, particularly carbon-fiber reinforced high performance composites directly to metal substrates have been inadequate, unreliable and/or unsuccessful.

Thus, there is a need in the art for a fiber-reinforced thermoplastic composite that is capable of being strongly and directly adhered to a base metal. There is also a need for articles formed using such composites and base metals and for methods of making such articles that result in articles which incorporate fiber-reinforced thermoplastic composites that are effectively and directly adhered to the base metal.

### BRIEF SUMMARY OF THE INVENTION

The invention includes a composite comprising a continuous fiber material and a thermoplastic, wherein the composite is capable of being directly adhered to a base metal and the composite has a coefficient of thermal expansion substantially the same as a coefficient of thermal expansion of the base metal.

The invention further includes an article comprising, (a) a composite comprising a continuous fiber material and a thermoplastic; and (b) a base metal, wherein the composite is directly adhered to a first surface of the base metal and the thermoplastic has a coefficient of thermal expansion substantially the same as a coefficient of thermal expansion of the base metal.

A method of making an article is also within the scope of the invention and comprises (a) contacting a thermoplastic/fiber material composite with a first surface of a base metal; (b) contacting a release sheet with a top of the thermoplastic/fiber material composite; (c) contacting a first surface of a mold with the release sheet and applying heat and pressure to the thermoplastic/fiber material composite sufficient to directly adhere the thermoplastic/fiber material composite to the first surface of the base metal to form an article; and (d) removing the release sheet from the article.

The invention further includes a composite comprising a fiber material and a thermoplastic, wherein the composite is capable of being directly adhered to a base metal and the composite has a coefficient of thermal expansion substantially the same as a coefficient of thermal expansion of the base metal, wherein the composite is directly adhered to the base metal using compression molding.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a magnified photograph of a composite of 12 K-carbon woven fiber material and PEEK thermoplastic according to one embodiment of the invention;

FIG. 2 is a magnified photograph of a composite of 3 K-carbon woven fiber material and PEEK thermoplastic according to a further embodiment of the invention;

FIG. 3 is a cross-sectional side elevational view of an article being formed in accordance with one embodiment of the method in using a steel mold, a release sheet, a base metal and a thermoplastic/woven fiber material composite in a heated press;

FIG. 4 is a photograph of a top plan view of a 3 K-carbon fiber material/PEEK composite adhered to a steel disk base metal;

FIG. 5 is a photograph of a top plan view of a woven carbon fiber material/PEEK composite adhered to a thrust bearing pad;

FIG. 6 is a photograph of a perspective side view of the thrust bearing pad of FIG. 5; and

FIG. 7 is a drawing of a perspective view of a metallic thrust bearing assembly having a woven carbon fiber material/PEEK composite adhered to two thrust pads.

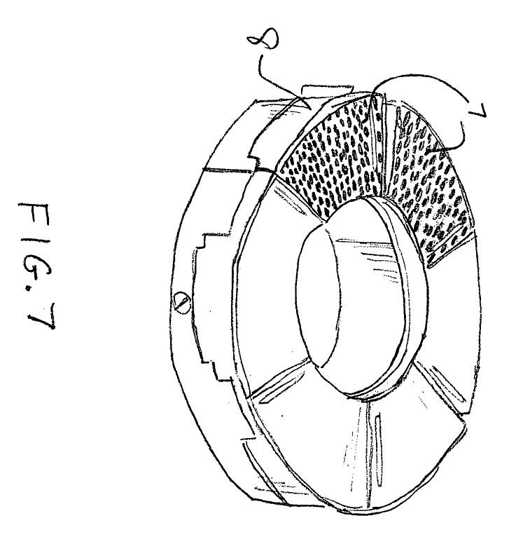

### DETAILED DESCRIPTION OF THE INVENTION

Thermoplastic/fiber material composites may be used according to the method of the invention to be directly adhered to metallic surfaces, such as steel to provide articles having useful properties for various applications. The invention further includes particular composites of the invention and articles formed from them which use thermoplastics such as polyarylene ketone and fiber material, preferably carbon fiber material, to provide excellent physical, chemical and thermal resistance. The composites are capable of being strongly and directly adhered, i.e. bonded, to a base metal to form such articles. Preferred materials for such composites include continuous fiber, more preferably continuous carbon fiber, and most preferably woven carbon fiber material and various thermoplastics, including polyphenylene sulfide (PPS), polyetherimide (PEI), liquid crystal polymer (LCP), polysulfone, and thermoplastic copolymers of tetrafluoroethylene and hexafluoropropylene or of tetrafluoroethylene and perfluoroalkylvinylether, and polyarylene ketones and their derivatives, including PEK, PEEK, PEKK and/or their derivatives. Also possible for use within the invention are low moisture thermosetting materials such as certain epoxies and thermosetting materials having similar hygroscopic properties which are similar to thermoplastic properties. For the purpose of convenience and simplification herein, such materials will be included within broad reference to thermoplastics, since they may be substituted in the present invention in place of the thermoplastic material. While these thermoplastics are preferred, the list should not be considered to be exhausted, and one skilled in the art would understand based on this disclosure that other thermoplastics could be used in the invention without departing from the scope thereof.

In the present invention the composite is formed such that the composite has a coefficient of thermal expansion substantially the same as a coefficient of thermal expansion of the base metal, in this manner the bonding and other optimal properties are best achieved. As used herein “substantially the same coefficient of thermal expansion” does not mean the coefficients are necessarily identical, but should be such that the thermal coefficient of expansion of the composite is no greater than five times the thermal coefficient of expansion of the base metal and preferably no greater than three times the thermal coefficient of expansion of the base metal. While it is preferred that they be as close as possible, such variation is within the scope of the invention for providing the composites and articles herein.

An article according to the invention comprises a composite material and a base metal to which the composite is directly, preferably permanently, adhered. The composite materials of the invention are preferably formed of continuous fiber material, such as glass, aramid, ceramic, and carbon fibers and mixtures thereof, and more preferably woven carbon fiber or other filamentous material which is impregnated with a thermoplastic, preferably polyarylene ketones and their derivatives such as those noted below. It is preferred further that the continuous fibers be long fibers of at least about 6 mm, and in some preferred embodiments, more at least 13 mm as described further below. In the articles and method of the invention, the composite(s) are directly adhered to a base metal which is preferably steel or similar metals, metal alloys or metallic filled composite materials.

Preferably the fiber material used in the invention comprises carbon fiber material which includes continuous fibers, such as a woven carbon fiber material. The continuous fibers in the material are preferably at least about 6 mm, and more preferably about 13 mm in length, and more preferably extend the length of the article to be formed, such length being measured longitudinally along a fiber. However, such materials may be longer or shorter depending on the particular properties and matrices desired for the articles to be formed. As such, it would be understood that the fiber length can be varied to provide correspondingly varied composite properties for a surface material for the articles of the invention within the scope of the invention. Since applicants have invented a unique compression molding technique for directly bonding fiber/thermoplastic composites to a base metal surface, as described further hereinbelow, it is also within the scope of the invention that in addition to continuous and woven carbon fiber thermoplastic composites, that chopped fiber/thermoplastic composites, which are well known in the art, using thermoplastics as described herein can also be used without departing from the spirit of the invention.

The composites of the invention preferably include woven fibers, particularly woven carbon or graphitic fibers which can be formed into sheets, cloth or fabrics and which can include thousands of individual continuous carbon fibers or filaments that are grouped together into strands called tows. The tows preferably are immersed in and/or impregnated with thermoplastic using any acceptable impregnation or immersion method known or to be developed in the art. The thermoplastic may be provided first to the fibers (fully impregnated or in solid form for later heat bonding to the fiber) and then the fibers woven into cloth or, conversely, the fibers may be first woven into cloth and then immersed in and/or impregnated with thermoplastic. However, it is also possible, and in some embodiments preferred to cover the fabric surface with a polymer in solid form, such as a polymer powder, and heat the polymer to coat and/or impregnate the fabric in that manner. Thus, while some methods of impregnation or coating of the fabric are preferred over others, the precise manner in which the polymer and fabric are brought together to form a composite may vary provided that the composite is formed. Many such methods of impregnation and fabric coating are known in the art. It should be understood based on this disclosure that all of such methods, and methods yet to be developed would be contemplated as within the scope of the invention.

Tow sizes are generally rated with a “K” designator. The “K” designator represents the number of fibers per tow. The most common and presently preferred sizes are 3 K (3000 individual carbon filaments), 6 K and 12 K although other sizes are possible.

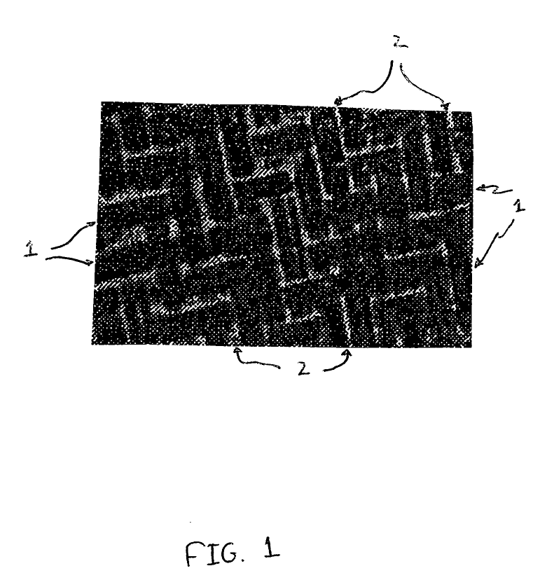

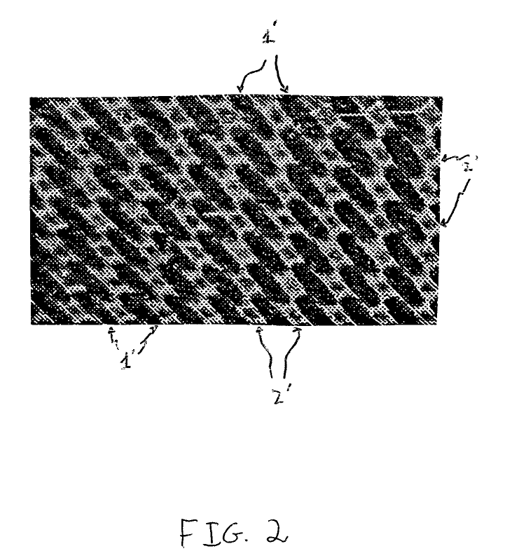

FIG. 1 is a magnified photograph of a 12 K-carbon fiber woven material and PEEK composite which shows carbon fiber tows 1 woven and impregnated with a PEEK thermoplastic matrix 2. Similarly, FIG. 2 is a magnified photograph of a 3 K-carbon woven carbon fiber material and PEEK composite having carbon fiber tows 1′ impregnated with a PEEK thermoplastic matrix 2′. A variety of weaves and woven designs may be utilized according to the invention, including plain, satin and twill weaves and variations thereof, although the 5-Harness Satin weaves, 2×2 Twill weaves and plain weaves are preferred.

High performance thermoplastics have the benefits of solvent resistance, low moisture absorption, light weight, as well as high strength, high modulus and toughness over a wide temperature range. The inventors of the present invention have found that the use of those thermoplastics noted above, and particularly the polyarylene ketone-based materials such as polyarylene ether ketone (PEKs), polyarylene ether ketone ketone (PEKKs), polyarylene ether ether ketone (PEEKs), and derivatives thereof, most preferably PEEK, provide desirable material characteristics when combined fiber materials in composite form, particularly woven carbon fiber material. Such composites effectively adhere to steel and/or other metals and alloys for use as base metals in accordance with the invention.

Polyarylene ketone based materials are inherently flame resistant, moisture absorption, excellent for chemical resistance, especially solvent resistance, and are to a large extent radiation resistant. They are also tough with excellent abrasion resistance and can withstand temperatures of about −280° F. (about −173° C.) to about 300° C. Polyarylene ketone based materials when impregnated into a fiber matrix to form a composite, particularly woven carbon fiber provide a highly advanced composite(s) that have applications, not only as friction and wear composites, but as composites of the highest quality for use in the aerospace, aircraft, nuclear and petroleum engineering fields as well as many other industrial and non-industrial fields.

PEEK is known to withstand temperatures in excess of 300° C. for significant periods of time without undergoing chemical decomposition. At room temperature it is a semi-crystalline thermoplastic polycondensate having a melting point of approximately 343° C. PEEK also has a low flammability and good resistance to chemical attack. Further, according to the invention PEEK in combination with woven carbon fiber tows provides superior bonding strength to a base metal when the method of the present invention is applied.

The polyarylene ketone based materials for use in the present invention are intended to encompass derivative thermoplastics having any a variety of arylene linkages, including, without limitation, para-phenylene linkages, meta-phenylene linkages or combinations thereof, depending on the particular properties or combination of properties desired in the end product.

By “derivatives” it is meant any compound that includes, for example, a polyarylene ketone backbone but which also has other functional group(s) or subgroup(s) attached to this backbone. Therefore, the polyarylene ketone derivatives may include, without limitation: PEK and its derivatives such as, for example, materials of the structure of formula (I) below:

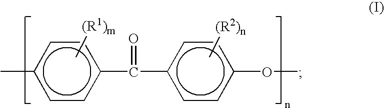

PEEK and its derivatives, such as, for example, materials of the structure shown in formula (II) below:

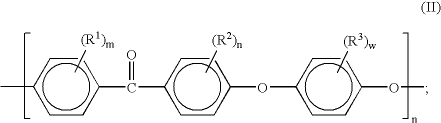

PEKK and its derivatives, such as, for example, materials of the structure shown in formula (III) below:

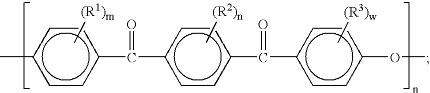

In formulae (I) through (III), above, R¹, R², and R³ may independently include substituted and unsubstituted and branched or straight chain groups including, but not limited to aliphatic groups, heterocyclic groups; alkyl groups, alkenyl groups, alkynyl groups, aryl groups, aldehyde groups, phenol groups, and similar structures. Such groups may further be functional groups or may contain functionalities, including without limitation, carboxyl, hydroxyl, sulfonated, aminated, amino acid, nitrated, carboxylic acid, and the like. It is preferred, however, that in providing functionality and/or substituted groups, the desirable physical properties of the resulting composites are not significantly deteriorated.

The thermoplastic or thermoplastic derivative selected may be amorphous or semi-crystalline grade, depending on the specific properties desired. It is also within the scope of the invention that if PEK, PEEK, or PEKK and/or its derivatives or any of the other above-listed suitable thermoplastic materials are used as the thermoplastic which is within the scope of the invention, such thermoplastics of the invention may also be mixed with, melt mixed or otherwise blended with one or more blending thermoplastics and/or compatibilizers known in the art or to be developed to provide a varied range of composite surface and wear properties, including, without limitation other polymers of the same basic type, and for example, homopolymers and copolymers of the following: LCP, polyetherimide, polyimide, polysulfone, polyphenylsulfone, polyphenylene sulfide, polyethersulfone, polyolefins, polyacrylates, polymethacrylates, polystyrenes, polyurethanes, polybutadiene-styrenes, polyacrylonitrile-butadiene-styrenes, polyamides, polycarbonates, and similar polymers, including those which may improve and/or enhance the thermoplastic properties and the hygroscopic thermoset epoxies noted above. Such thermoplastics blends, mixtures or combinations may include any known in the art which are useful to improve the processability or other properties of the thermoplastic material without significantly degrading its thermal stability. Blending polymers which may be added in melt or powder additive form may improve the processability of the thermoplastic in the composite include, without limitation, polytetrafluoroethylene (PTFE), other fluorinated thermoplastics, polyalkylene oxides such as polyoxymethylene (POM), polysulfones (PSU), polyether sulfones (PES) and/or polyetherimides (PEI). While those of ordinary skill in the art will appreciate that the amount of any polymer(s) present in any thermoplastic blend will vary depending on the properties desired, it is generally preferred that if the thermoplastic is primarily PEK, PEKK or PEEK and/or their derivatives, that any additional blending polymer(s) be present in an amount of about 2% by weight to about 98% by weight, with a more preferred amount of about 25% by weight to about 75% by weight and a most preferred amount of about 40% to about 60% by weight based on the total weight of the thermoplastic used in the composite.

In addition to blending materials, it is within the scope of the invention that additives may be provided to the thermoplastic composite preferably by blending with the thermoplastic matrix material. Exemplary additives include silicon dioxide, silica, alumina, talc, glass fibers, glass spheres, PTFE short fibers, TFE copolymer short fibers, ribbons or platelets, plasticizers, flame retardants, titanate whiskers, compatibilizers, rheological or thixotropic agents, ultraviolet absorbers, antistatic agents (which may also be incorporated through use of functional groups and/or graft copolymers provided to the thermoplastic matrix), chopped carbon fibers, and other similar fillers, tribological additives and reinforcing agents. It is preferred that such additives be present in an amount no greater than about 10% of the composite based on the total weight of the composite. In addition, it is within the scope of the invention that the fiber material may be a blend material, i.e., that more than one fiber may be used in combination as a matrix material for impregnation prior to addition of the thermoplastic(s), including for example, without limitation, glass/carbon, glass/graphite/carbon, graphite/carbon, aramid/glass, ceramic/glass and PTFE or TFE copolymer fiber/carbon blends. In fiber blends or combined fibrous reinforcements, additional fibers may be provided in the form of chopped strands, filaments or whiskers to the fiber matrix. Further, such blends may include any range of potential woven or blended fibrous materials provided sufficient strength and other desired properties are retained.

It will be understood, based on this disclosure, that the amount of fiber material, preferably continuous or woven carbon fiber, used for reinforcement in the thermoplastic matrix of the composite of the present invention will vary depending on several factors, including the type of thermoplastic, or derivative thereof, and any specifically desired properties of the end product. However, it is preferred that the fiber material be present in the composite in an amount of about 30% by volume to about 70% by volume, or more preferably about 40% by volume to about 60% by volume based on the total volume of the composite.

In general, regardless of whether the product contains one or more blended thermoplastics, the total thermoplastic content in the composite is preferably about 70% by volume to about 30% by volume based on the total weight of the composite. The preferred amount is about 60% by volume to about 40% by volume.

An additional feature of the present invention is an article which includes a composite such as the composites described above and a base metal in which the composite is directly adhered to a first surface of the base metal. The composite may be any of those described above, but preferably includes a continuous carbon fiber, and more preferably a woven carbon fiber material. While any of the above preferred thermoplastics may be used for the composite, the preferred thermoplastic is selected from a group consisting of polyarylene ether ketone, polyarylene ether ketone ketone, polyarylene ether ether ketone, and derivatives thereof.

Such articles may be, for example, any of those listed in the Background Section herein, including without limitation, a mechanical seal face, a thrust bearing pad, a clutch face, a journal bearing (integral and segmented), a journal bearing pad, a brake pad, automotive parts, or similar articles which require a metallic body and a wear surface. It will be understood, however, based on this disclosure, that other articles having industrial application made using the method of this invention are also included within the scope of the invention.

The invention further includes a method of making an article, in which a composite according to the invention or any similar thermoplastic/fiber material composite is contacted with a first surface of a base metal. A release sheet is further contacted with the top of the thermoplastic/fiber material composite. A first surface of a mold is then contacted with the release sheet, and heat and pressure are applied to the thermoplastic/fiber material composite sufficient to directly adhere the thermoplastic/fiber material composite to the first surface of the base metal to form an article according to the invention. The release sheet is then removed from the article. The method provides improved strength and bonding properties.

In a typical woven sheet, fabric or cloth, tows of fibers, preferably carbon fibers, are interwoven with other tows in the horizontal and vertical directions such that the properties of a carbon fiber thermoplastic composite material are similar, if not equivalent, in either direction and greatest in both directions. However, individual sheets of woven fiber, preferably sheets of carbon fiber, can be immersed in or impregnated, or coated with powder followed by heating (or other impregnation methods) with thermoplastic resin and then stacked on top of other sheets already woven. The orientation of various sheets in relation to other sheets in a stack have been found to directly influence the physical properties, including strength, of the stacked sheets once compressed and cured. It is possible to manufacture various fiber/thermoplastic composites such that desired physical properties may be obtained upon consolidating the immersed, impregnated or polymer powder/heat molded stacked sheets by, for example, use of compression molding.

The base metal used in the method and article of the invention may be any metal or metal alloy, but is preferably carbon steel, and more preferably 4140 or carbon steel. However, other metals and metal alloys such as iron, stainless steel, titanium, palladium, tantalum, copper, vanadium, ruthenium, zinc, bronze, tin, aluminum, hafnium, gold, silver, silicon, gallium and the like may also be used.

In the method of the invention, it is preferred that once the composite is formed as noted above and/or using any acceptable technique for forming a composite known in the art or to be developed, the first and/or second surfaces of a base metal are first prepared for receiving the composite. The first surface of the base metal is the surface which will contact the composite material. The second surface is the surface opposite the first surface. While it is not necessary to prepare both surfaces, it is preferred to prepare at least the first surface, and more preferably the first and second surfaces. The surfaces may be prepared by, for example, sand blasting them to remove any oxidation and debris which may be on the surface of the metal and to roughen the bonding surface. However, other suitable surface grinding, polishing or cleaning solutions may be used. Such preparation should continue until a substantially uniform finish is achieved. Materials prepared by this method can preferably be sand blasted in a sand blasting cabinet or room depending on the size of the base metal. The blast medium type and size will depend on several factors including the size of the base metal to be blasted. The first surface and/or the second surface of the base metal should then be cleaned with lint-free cloth materials and appropriate cleaning agents including, for example, cleaning solvents and alcohol. The amount of base metal preparation necessary will vary depending on many factors including the cleanliness of the starting material and the type of dirt, debris or other undesirable substances present on the face of the base material, and the particular specification requirements for the end article. Variations of such techniques to optimize the resulting properties of the articles depending on the materials used are within the skill of those in the art.

Next, the composite, preferably the polyarylene ketone and/or derivative/woven carbon fiber material composite, which is already formed, is preferably cut such that the transverse cross section of the composite is substantially, if not identical in configuration to the transverse cross section of the first surface of the base metal to which it will be adhered or bonded, i.e., the base metal is preferably of generally cylindrical configuration with a circular transverse cross section throughout. The composite is then placed so as to be in contact with the first surface of the base metal. A release sheet is placed over the top of the composite material so as to contact the composite material. It is also preferred, in some embodiments, that a mold, which is preferably formed of, but not necessarily formed of, the same metal as the base metal is then placed in contact with the release sheet that is in contact with the top of the composite. It is further preferred that the mold also have a prepared surface. It also acceptable, but not necessary, to use a mold which has first and second surfaces which have cross sections (such as a circular cross section) that are the same as the cross section of the base metal in shape.

It is further within the scope of the invention that the method described above could be used to bond composite directly to more than one surface of the base metal. For example, such multi-surface bonding could occur simultaneously using a second release sheet and composite on the second surface of the base metal opposite the first composite. A second mold or other hard surface is then applied so as to directly bond the composite to the second surface. The same procedure may be used simultaneously with directly bonding the first composite to the base metal or the procedure may be used after the first composite is bonded, however, it is preferred to attach the composites simultaneously to avoid multiple process steps and additional processing of the first composite once it is directly bonded.

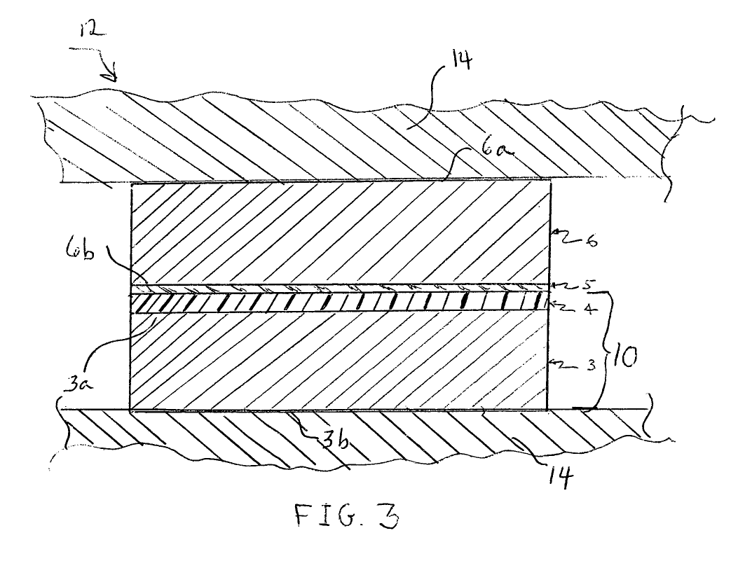

Several different types of release sheet materials can be used effectively as long as they have non-stick characteristics similar to thermal imides, for example. Also, the mold is, more preferably, of the same size, shape and weight as the base metal. As best shown in FIG. 3, a composite/base metal combination, generally referred to as 10 includes a base metal 3 which has a first surface 3a and a second surface 3b and a composite 4. The first surface 3a of the base metal is preferably in facing engagement with the composite 4. The release layer 5 is on top of the composite 4 and structure 10. A mold 6 having a first surface 6a and a second surface 6b maintains thermal mass equality when placed in a molding cycle.

The mold is then placed in a heated press 12 preferably having two opposing platens 14 (or can be placed in any apparatus capable of providing heat and pressure to the composite/metal structure 10) and cycled through a molding cycle. The type and size of the press 12 that can be effectively used is a function of the size and configuration of the structure 10 being bonded, however, the press must be capable of applying pressures from about 30 to about 70 bars, preferably at least about 65.5 bars of pressure (about 950 p.s.i.) (in the case of PEEK/carbon composites) or greater to the mold while achieving a temperature of about 150° C. to 400° C. or more. It will be understood, however, that the temperature and pressure cycles chosen may vary depending on the thermoplastics used in the composite 4 and the metal substrate or base metal used. The process is then monitored using, for example, either set time or temperature monitoring. If the temperature is used to determine the duration that pressure is applied to the mold, it is monitored by placing a thermocouple, or comparable temperature measuring device, at an edge of the composite. An alternative, although not preferred embodiment of the present invention further includes impregnating the fiber matrix with solid thermoplastic, such as providing thermoplastic powder, pellets, flake or sheet to fiber sheets, preferably carbon fiber sheets so that the thermoplastic resin is impregnated in the sheets and then curing the composite during the molding cycle. However, the pressure for such an operation is preferably greater than that noted above to effectively form the composite and directly adhere it to a metallic surface.

Once the desired temperature is achieved at the edge of the composite (or the set time has been reached), the press or similar apparatus is opened and the structure 10, release sheet 5 and mold 6 are removed as an assembly and are cooled. Preferably, they are placed in a cold press where at least about 60 bars, preferably at least about 30 to 70 bars of pressure or more, preferably at least about 65.5 bars in the case of PEEK/carbon embodiments, are applied to the mold 6 and the second surface 3b of the base metal. Optionally, water, or a comparable cooling fluid, preferably at about 20° C. to 40° C., more preferably about 20° C., can be passed through the platens 14 to help cool the mold 6 and base metal/composite structure 10 as well as the release sheet 5. Air cooling is also acceptable. The cooling rate may be controlled by controlling the temperature and/or flowrate of any cooling fluid and monitoring the temperature of the composite by placing a thermocouple, or comparable temperature measuring device, at an edge of the composite. Preferably, the cooling rate is controlled to be at least 10° C. per minute, however, this may be varied depending on the particular materials used. The mold 6, release sheet 5 and structure 10 are then removed as an assembly from the cold press or similar cooling apparatus when the composite material reaches room temperature or about 20° C.

After the mold 6, release sheet 5 and structure 10 are removed from the cold press they go through a de-molding procedure. This procedure involves first removing the mold 6 and then removing the release sheet 5. Next, the composite is preferably trimmed using appropriate cutters or shears and/or a grinder, as necessary, so that the outer edges of the resulting article formed from structure 10 result in a smooth, nearly seamless transition between the composite and the base metal. It is also possible to have the composite machined tooled without use of hand tooling. It is thus preferred that when complete, the transverse cross sectional configuration of the composite surface in contact with the base metal be substantially the same as, if not identical to, the transverse cross sectional configuration of the first surface 3a of the base metal

The invention will now be explained in further detail with reference to the following, non-limiting Examples:

### EXAMPLE 1

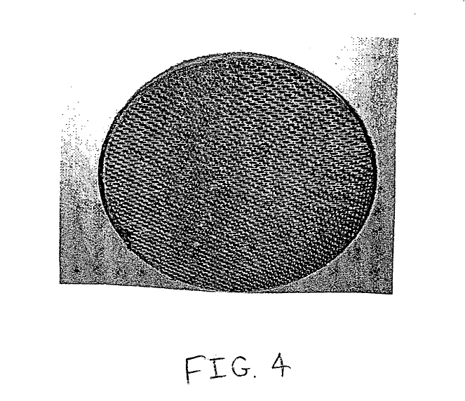

FIG. 4 shows a 3 K-carbon/PEEK composite adhered to a steel disk according to the present invention. Two steel disks (ASTM 516 grade 70, 6.25 inch diameter, 0.5 inch thickness), a sheet of Kapton®, a previously formed Porcher 3 K-carbon/PEEK composite (150 grade PEEK, 50% by volume; 43% by weight of the composite), a hydraulic press, and a cold press were used to adhere the composite to one of the steel disks which served as the base metal. The other disk was used as a mold. The steel disks were prepared in a sand blasting cabinet where the blasting medium was garnet and the blasting nozzle was held approximately 1.5 inches away from the steel disk surfaces. Once a uniform finish was achieved, the steel disks were removed from the cabinet and cleaned with a lint-free rag and isopropyl alcohol.

The previously formed 3 K-carbon/PEEK composite was cut to the transverse cross sectional shape of the steel disks by placing the mold disk on top of the composite and tracing the composite with a razor blade thereby cutting through the composite such that it formed the same size and shape as the surface of the disks. After the composite was cut it was placed on top of the base metal, steel disk, after which the release sheet of Kapton® (thermal polyimide) is placed on top of the composite. The second mold disk was then placed on top of the Kapton® sheet and the mold disk, release sheet, and composite/base metal steel disk structure were placed in a 750° F. (400° C.) hydraulic heated press and about 65.5 bars of pressure (950 p.s.i.) were applied against the mold, release sheet and structure. The temperature was monitored by placing a thermocouple probe on the edge of the composite and when its temperature reached about 390° C., the press was opened and the mold, release sheet and structure were removed. The mold, release sheet and structure were then placed in a cold press and again about 65.5 bars of pressure (950 p.s.i.) were applied. The cooling rate of the composite material was controlled at 10° C. per minute and the temperature of the composite was measured by a thermocouple attached to an edge of the composite. The press was stopped and the mold, release sheet and structure were removed when the temperature of the composite reached room temperature or about 20° C. The mold was then put through a de-molding procedure.

During the de-molding procedure, the mold disk in contact with the release sheet was removed. The release sheet was then removed from the composite using razor blades as necessary to separate the release sheet from the composite. Finally, the composite was trimmed with sheet metal shears and smoothed with a grinder in order to obtain a smooth seam between the 3 K-carbon/PEEK composite and the base metal, steel disk.

### EXAMPLE 2

The same materials and equipment are used in this Example as in Example 1, with the exception that the composite in this Example is a Hexcel 12 K-carbon/PEEK composite (150 grade PEEK, 50% by volume; 40% by weight of the composite). The method of manufacture as provided in Example 1 for adhering the composite to a steel disk is carried out to form an article.

### EXAMPLE 3

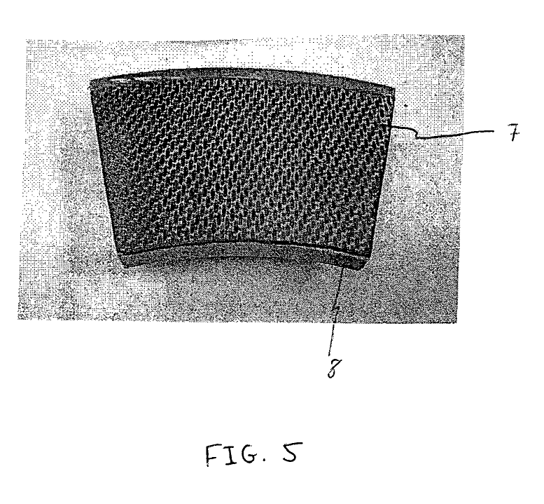

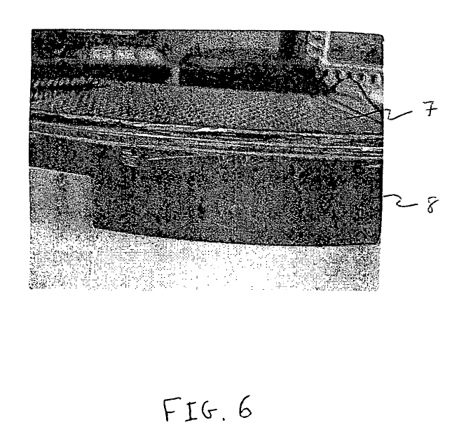

FIGS. 5 and 6 show a 3 K-carbon/PEEK composite designated as 7 adhered to a steel thrust bearing pad 8. The thrust bearing pad 8 having the composite was formed as in Example 1 with the exception in this Example that the base metal was a steel thrust bearing pad 8 instead of a steel disk. The same method of manufacture as in Example 1 was used for adhering the composite material 7 to the thrust bearing pad 8.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A composite comprising a continuous fiber material and a thermoplastic, wherein the composite is capable of being directly adhered to a base metal and the composite has a coefficient of thermal expansion substantially the same as a coefficient of thermal expansion of the base metal.

2. The composite according to claim 1, wherein the continuous fiber material is a carbon fiber material.

3. The composite according to claim 2, wherein the carbon fiber material is woven carbon fiber.

4. The composite according to claim 2, wherein the carbon fibers are at least 6 millimeters in length as measured longitudinally.

5. The composite according to claim 1, wherein the woven carbon fiber material is selected from a group consisting of 5-Harness Satin, 2×2 Twill and plain weave.

6. The composite according to claim 1, wherein the thermoplastic comprises about 70% to about 30% by volume of the composite based on a total volume of the composite.

7. The composite material according to claim 6, wherein the thermoplastic comprises about 60% to about 40% by volume of the composite based on the total volume of the composite.

8. The composite material according to claim 1, wherein the thermoplastic is selected from a group consisting of polyarylene ether ketone, polyarylene ether ketone ketone, polyarylene ether ether ketone, and derivatives thereof

9. An article comprising,
(a) a composite comprising a continuous fiber material and a thermoplastic; and
(b) a base metal, wherein the composite is directly adhered to a first surface of the base metal and the thermoplastic has a coefficient of thermal expansion substantially the same as a coefficient of thermal expansion of the base metal.

10. The article according to claim 9, wherein the continuous fiber material is a continuous carbon fiber material.

11. The article according to claim 9, wherein the article is selected from the group consisting of a mechanical seal face, thrust bearing pad, a journal bearing, and a segmented journal bearing pad.

12. The article according to claim 9, wherein the thermoplastic is selected from a group consisting of polyarylene ether ketone, polyarylene ether ketone ketone, polyarylene ether ether ketone, and derivatives thereof.

13. A method of making an article, comprising
(a) contacting a thermoplastic/fiber material composite with a first surface of a base metal;
(b) contacting a release sheet with a top of the thermoplastic/fiber material composite;
(c) contacting a first surface of a mold with the release sheet and applying heat and pressure to the thermoplastic/fiber material composite sufficient to directly adhere the thermoplastic/fiber material composite to the first surface of the base metal to form an article; and
(d) removing the release sheet from the article.

14. The method according to claim 13, wherein the thermoplastic is selected from a group consisting of polyarylene ether ketone, polyarylene ether ketone ketone, polyarylene ether ether ketone and derivatives thereof.

15. The method according to claim 13, further comprising preparing the first surface of the base metal and a second surface of the base metal to provide a substantially uniform finish to the first and second surfaces of the base metal prior to step (a).

16. The method according to claim 13, further comprising cutting the thermoplastic/fiber material composite such that it has the same transverse cross section as the first surface of the base metal.

17. The method according to claim 16, wherein the thermoplastic/fiber material composite further has the same transverse cross section as a second surface of the base metal.

18. The method according to claim 13, wherein the mold comprises a second metal.

19. The method according to claim 18, wherein the second metal is the same as the base metal.

20. The method according to claim 13, wherein a transverse cross section of the first surface of the base metal is substantially the same configuration as a transverse cross section of the mold.

21. The method according to claim 13, wherein heat and pressure are applied to the thermoplastic/fiber material composite via a heated press which contacts a second surface of the mold and a second surface of the base metal.

22. The method according to claim 13, wherein the pressure is at least about 60 bars.

23. The method according to claim 13, wherein the heat is applied at a temperature which is at least about 400° C.

24. The method according to claim 13, further comprising removing the mold, the release sheet and the article from the heat, and cooling the mold, the release sheet and the article, prior to removing the release sheet.

25. The method according to claim 24, wherein the cooling is effected by placing the mold, the release sheet and the article in a cold press such that at least about 60 bars of pressure is applied until the mold reaches a temperature of about 20° C.

26. The method according to claim 13, wherein the fiber material is a woven carbon fiber material.

27. A composite comprising a fiber material and a thermoplastic, wherein the composite is capable of being directly adhered to a base metal and the composite has a coefficient of thermal expansion substantially the same as a coefficient of thermal expansion of the base metal, wherein the composite is directly adhered to the base metal using compression molding.

28. The composite according to claim 27, wherein the material is a carbon fiber material which is a chopped carbon fiber.

29. The composite according to claim 27, wherein the carbon fiber is continuous carbon fiber material.

30. The composite according to claim 27, wherein the carbon fiber material is continuous woven carbon fiber material.
